(19) United States
(12) Patent Application Publication
(10) Pub. No.: US 2011/0147491 A1
(43) Pub. Date: Jun. 23, 2011

(54) INTERNAL MIX AIR ATOMIZING SPRAY NOZZLE ASSEMBLY

(75) Inventors: Emily Pope, Glen Ellyn, IL (US); Daniel Vidusek, Hampshire, IL (US)

(73) Assignee: Spraying System Co., Wheaton, IL (US)

(21) Appl. No.: 12/644,074

(22) Filed: Dec. 22, 2009

(51) Int. Cl. B05B 7/00

(52) U.S. Cl. 239/398

(57) ABSTRACT

An internal mix air atomizing spray nozzle assembly comprising a nozzle body with a liquid discharge orifice defined by a relatively small diameter nose portion and an air cap having a central opening disposed in surrounding relation to the nose portion for defining an annular pressurized air passageway surrounding the liquid discharge orifice. To facilitate intermixing of liquid particles discharging from the air cap discharge orifices and for reducing negative pressures between the discharging flow streams, the air cap has an internal mixing chamber larger in diameter than the annular pressurized air discharge orifice and is formed with a plurality of circumferentially spaced discharge orifices oriented in skewed relation to a central axis of the nozzle. In the illustrated embodiment, the internal mixing chamber is defined by a cylindrical cavity within the air cap and a separate insert mounted in an upstream end of the air cap.

### FIELD OF THE INVENTION

The present invention relates generally to air assisted spray nozzle assemblies, and more particularly, to air assisted spray nozzle assemblies in which pressurized liquid and air streams are directed into an internal mixing chamber defined by an externally mounted air cap for intermixing prior to discharge through a plurality of circumferentially spaced discharge orifices in the air cap into a conical spray pattern.

### BACKGROUND OF THE INVENTION

Internal mix air atomizing spray nozzle assemblies of the foregoing type are adapted for generating and directing a very fine liquid particle spray which has particular application in coating and evaporative cooling systems. A problem with such spray nozzle assemblies is that the pressurized streams of fine particles discharging from the circumferentially spaced discharge orifices can create negative pressures between the discharge orifices of the air cap drawing fine particles into contact and accumulation with external surfaces of the air cap, commonly referred to as bearding. Such bearding can be particularly troublesome in spraying coatings, and is undersirable in any case, because it can interfere with and impede the discharging spray and require costly shutdown, cleaning and maintenance of the spraying system.

Another problem such internal mix air atomizing spray nozzle assemblies is that the discharge orifices of the air cap tend to direct a plurality of distinct streams of liquid particles in a conical pattern which do not readily intermix and which fail to create a uniform full cone liquid particle distribution, particularly desirable for coating, humidification, and other spray applications. Due to the relatively small size of the air cap, attempts to increase the number of air cap discharge orifices in a manner that enhances intermixing of the plurality of atomized liquid particle flow streams and prevents bearding have not been successful.

Hence, the need exists for an internal mix air atomizing spray nozzle assembly which is adapted for directing a full cone spray pattern with a more uniform fine particle distribution and which operates without undesirable bearding on surfaces of the air cap.

### OBJECTS AND SUMMARY OF THE INVENTION

It is an object of the present invention to provide an internal mix air atomizing spray nozzle assembly which is adapted to generate a full cone spray pattern with fine particles more uniformly distributed throughout a conical spray discharge.

Another object is to provide such an internal mix air atomizing spray nozzle assembly as characterized above which is operable without undesirable bearding and coating of solid particulate matter on external surfaces of an air cap of the assembly that can impede spray performance or require maintenance.

A further object is to provide an internal mix air atomizing spray nozzle assembly of the above kind which, while relatively small in size, has a greater multiplicity of discharge orifices that facilitate intermixing of pre-atomized liquid particle flow streams and reduce negative pressures between the flow streams.

Still another object is to provide such an internal mix air atomizing spray nozzle assembly which is relatively simple in design, economical in manufacture, and reliable in operation.

Other objects and advantages of the invention will become apparent upon reading the following detailed description and upon reference to the drawings, in which:

### BRIEF DESCRIPTION OF THE DRAWINGS

FIG. 1 is a vertical section of an illustrative internal mix air atomizing spray nozzle assembly in accordance with the invention;

FIG. 2 is an enlarged end view of the air cap of the illustrated nozzle assembly, taken in the plane of line 2-2 in FIG. 1;

FIG. 3 is an exploded longitudinal section of the air cap of the illustrated spray nozzle assembly;

FIG. 4 is a vertical section of the illustrated spray nozzle assembly, taken in the plane of line 4-4 in FIG. 5;

FIG. 5 is a fragmentary end view of the air cap of the illustrated spray nozzle; and

FIG. 6 is an enlarged fragmentary view of one of the discharge orifices of the illustrated air cap.

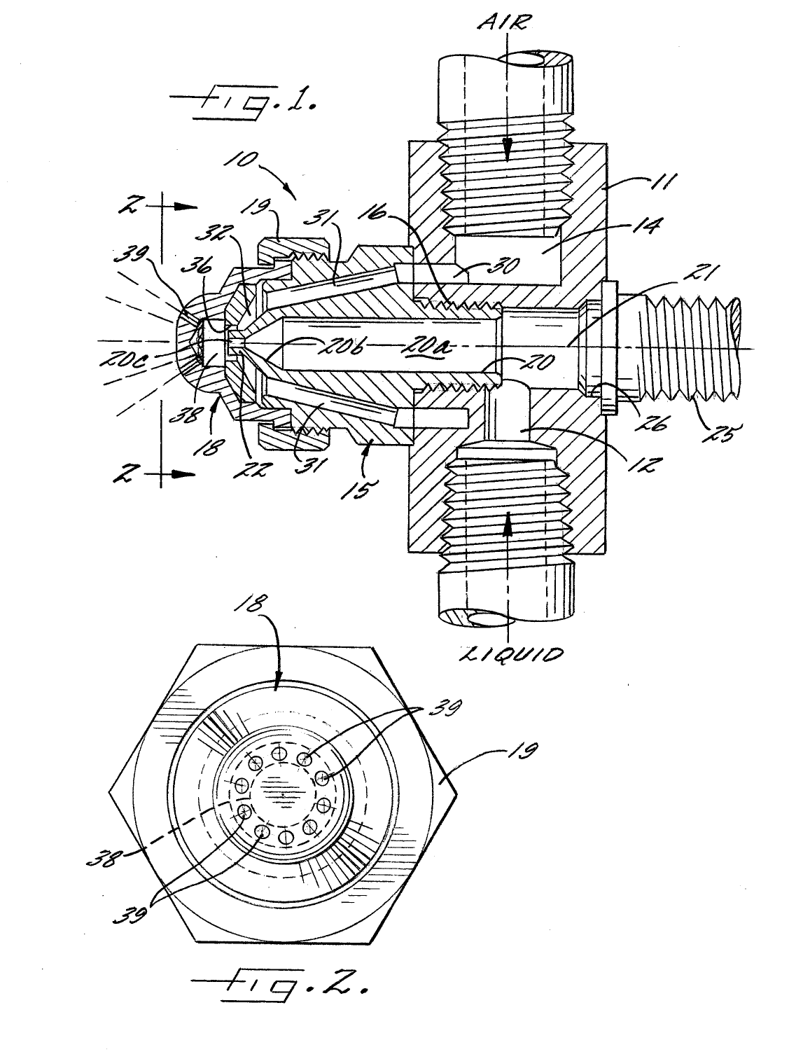

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

Referring now more particularly to the drawings, there is shown an illustrative internal mix air assisted spray nozzle assembly 10 in accordance with the present invention. The spray nozzle assembly 10 includes a nozzle body 11 formed with diametrically opposed liquid inlet and pressurized air inlet ports 12,14 respectively, a nozzle spray tip 15 affixed to the forward or downstream end of the nozzle body 11 by a threaded stem 16 of the nozzle spray tip 15, and an air cap 18 disposed in surrounding relation to the nozzle spray tip 15 and retained thereon by a retaining nut 19. The nozzle spray tip 15 has a liquid passageway 20 extending along a central axis 21 of the nozzle and communicating with the liquid inlet 12. The liquid passageway 20 in this case includes a relatively large diameter upstream portion 20a and an inwardly tapered conical portion 20b that communicates with a relatively small diameter discharge orifice 20c formed in a forwarding extending relatively small diameter, cylindrical nose portion 22 of the nozzle spray tip 15.

The spray nozzle assembly 10 in this case is supported by a support rod 25 positioned into a mounting opening 26 in a rear side of the nozzle body 11 in coaxial alignment with the central liquid passageway 20. It will be appreciated by one skilled in the art that alternatively the nozzle body 11 can be supported by other means and the central rear opening 26 may receive a valve needle for controlling the liquid flow through the spray nozzle assembly 10 under the control of a pneumatically actuated piston, such as disclosed in U.S. Pat. No. 5,899,387 assigned to the same assignee as the present application, the disclosure of which is incorporated herein by reference. While in the illustrated embodiment the nozzle body 11 and nozzle spray tip 15 are separate parts, it also will be understood that alternatively they may be formed as an integral single part.

The air inlet port 14 in this instance communicates with an annular air chamber 30 defined between the nozzle body 11 and nozzle spray tip 15, which in turn communicates with a plurality of inwardly tapered air passageways 31 formed in the nozzle spray tip 15 in circumferentially spaced relation about the central liquid passageway 20. The nozzle spray tip air passageways 31 each communicate with a conically configured annular air chamber 32 defined between the upstream side of the air cap 18 and a downstream inwardly tapered end of the nozzle spray tip 15.

The air cap 18 has a central opening 35 disposed in surrounding relation to the spray tip nose portion 22, which defines an annular air orifice 36 that communicates between the tapered air chamber 32 and an internal mixing chamber 38 of the air cap 18. The air cap 18 further is formed with the plurality of circumferentially spaced discharge orifices 39 which each communicate with the internal air cap mixing chamber 38. Hence, the direction of pressurized liquid and air to the inlet ports 12,14, respectfully, will result in the simultaneous discharge of liquid from the nozzle spray tip discharge orifice 20c and pressurized air from the annular air discharge orifice 36 for intermixing within the mixing chamber 38 and ultimate discharge through the plurality of the air cap discharge orifices 39.

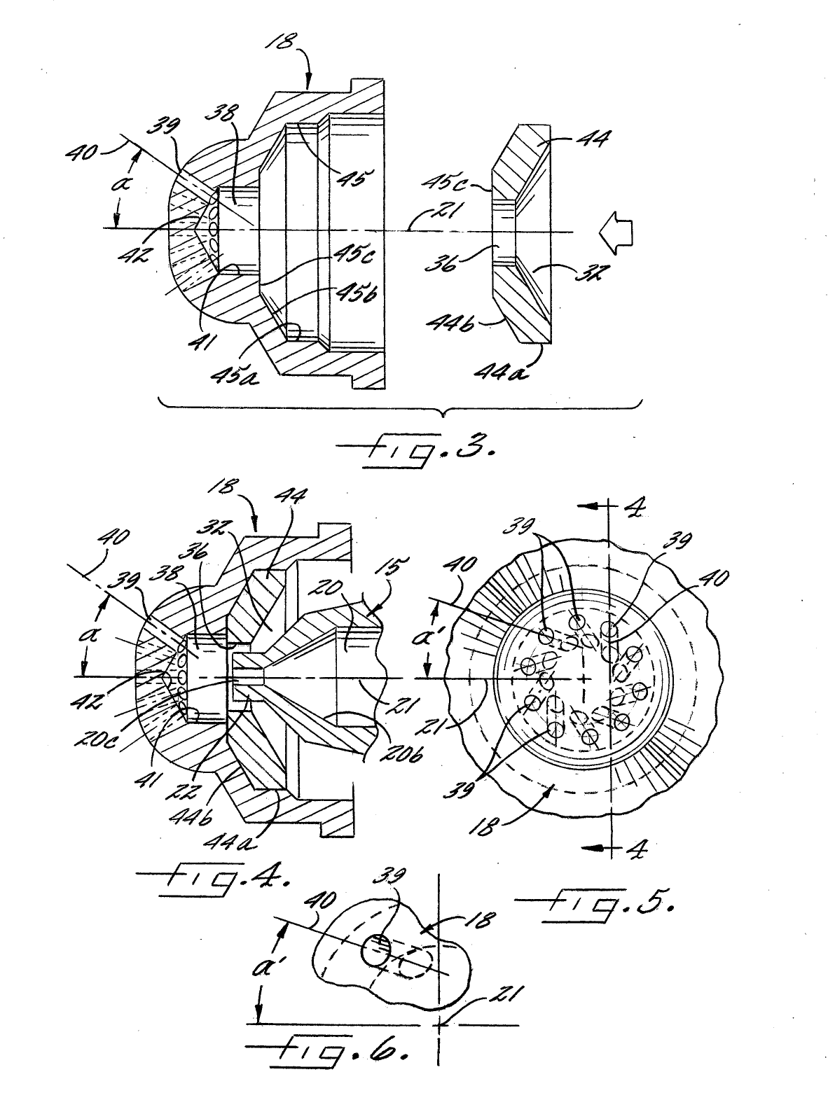

In accordance with one important aspect of the illustrated embodiment of the invention, the air cap internal mixing chamber 38 is larger in diameter than the annular air discharge orifice 36 so as to permit enhanced intermixing and pre-atomization of the pressurized liquid and air streams directed into the internal mixing chamber 38 prior to discharge from the circumferentially spaced air discharge orifices 39. To this end, in the illustrated embodiment shown in FIG. 4, the air cap mixing chamber 38 has a diameter of at least 30% greater than the outer diameter of the annular air discharge orifice 36, and most preferably at least 50% greater, so as to permit intermixing of the liquid and air streams in an area both downstream and radially outwardly of the pressurized liquid and air streams directed into the mixing chamber 38. In the illustrated embodiment, the internal air cap mixing chamber 38 is defined by a cylindrical wall 41 of the air cap 18 having a conically configured downstream end 42 and an annular insert 44 positionable in an upstream end of the air cap 18 that defines the central air cap opening 36.

The illustrated air cap 18 is formed with a counter bore 45 for receiving the air cap insert 44 immediately adjacent an upstream end of the cylindrical wall 41 of the mixing chamber 38. The counter bore 45 is formed with cylindrical, frustoconical, and transverse seating surfaces 45a,45b,45c, respectively, for receiving complementary formed seating surfaces 44a,44b,44c of the insert 44 in predetermined concentric relation to the cylindrical mixing chamber 38. As will be understood by a person skilled in the art, the counter bore 45 and mixing chamber walls 41,42 can be produced by economical machining operations performed from an upstream end of the air cap 18 and the insert 44 can similarly be economically machined.

In keeping with a further feature of this embodiment of the invention, the air cap discharge orifices 39 extend in skewed relation to the central axis 21 of air cap and nozzle spray tip liquid passageway 20, which unexpectedly has been found to minimize negative pressures between the discharging flow streams and reduce undesirable bearding of solid particulate material on external surfaces of the air cap, while enhancing intermixing of the flow streams discharging from the air cap discharge orifices 39. As used in the specification and claims, the term “skewed” means that the axes 40 of the discharge orifices 39 are oriented at an compound angle with respect to the central air cap and liquid passageway axis 21, namely at an acute angle both to a horizontal plane a extending through the central axis 21 of the nozzle as viewed in FIG. 3, and a vertical plane a′ extending through the central axis 21 of the air cap as viewed in FIGS. 5-6. With the flow streams discharging from the air cap directed both radially and tangentially with respect to the central air cap axis 21 the fine pre-atomized liquid particles tend to migrate more readily into a full cone spray pattern.

In keeping with still a further feature of this embodiment of the invention, the relatively large diameter internal air cap mixing chamber 38 and the skewed relation of the air cap discharge orifices 39 enable the air cap 18 to be formed with a greater number of discharge orifices 39 which additionally facilitate intermixing of the discharging liquid particles into a full spray pattern with reduced negative pressures between the discharging flow streams. Preferably, the spray nozzle includes at least nine discharge orifices 39, and most preferably, at least ten as depicted in the illustrated embodiment. The closer spacing between the skewed discharge orifices 39 is believed to both facilitate intermixing of the discharging flow stream into a conical spray pattern and minimize negative pressure between the discharging flow streams which otherwise create undesirable bearding of solid particulate material on the spray cap.

From the foregoing, it can be seen that an internal mix atomizing spray nozzle assembly is provided that is adapted to generate a full cone spray pattern while minimizing undersirable bearding. The spray nozzle assembly, which while relatively small in size, has a greater multiplicity of discharge orifices than heretofore possible that facilitate intermixing of discharging preatomized liquid particle flow streams and reduce negative pressures between the flow streams. Yet, the spray nozzle assembly is relatively simple in design, economical in manufacture, and reliable in operation.

1. An internal mix air atomizing spray nozzle assembly comprising:
a nozzle body formed with a central liquid flow passageway along a central axis thereof, said nozzle body having a liquid inlet for connection with a pressurized liquid supply and communicating with said central liquid flow passageway, said nozzle body having a downstream relatively small diameter, forwardly extending, cylindrical nose portion which defines a liquid discharge orifice of said central liquid flow passageway,
said nozzle body having an air inlet port for connection to a pressurized air source,
an air cap mounted in surrounding relation to said nose portion formed with a central mixing chamber concentric with said central liquid flow passageway and central axis into which pressurized liquid from said liquid discharge orifice discharges,
said air cap having a central opening disposed in at least partially surrounding relation to said nose portion, said air cap central opening and nozzle nose portion defining an annular air orifice coaxial with said liquid discharge orifice and central axis and in communication with said air inlet port for directing an annular pressurized air stream into said air cap mixing chamber for interaction with liquid discharging from said liquid discharge orifice for pre-atomizing the liquid into liquid particles,
said air cap mixing chamber having a diameter larger than the outer diameter of said annular air orifice, and
said air cap having a plurality of circumferentially spaced discharge orifices for directing pre-atomized liquid particles from said mixing chamber in a conical spray pattern.

2. The internal mix air atomizing spray nozzle assembly of claim 1 in which said air cap mixing chamber is defined by a cylindrical cavity within said air cap and a separate upstream insert that defines said central air cap opening.

3. The internal mix air atomizing spray nozzle assembly of claim 1 in which said air cap mixing chamber has a diameter at least 30% greater than the outer diameter of said annular air orifice.

4. The internal mix air atomizing spray nozzle assembly of claim 1 in which said air cap mixing chamber has a diameter at least 50% greater than the outer diameter of said annular air orifice.

5. The internal mix air atomizing spray nozzle assembly of claim 1 in which said air cap is formed with at least nine discharge orifices.

6. The internal mix air atomizing spray nozzle assembly of claim 1 in which said air cap is formed with at least ten discharge orifices.

7. The internal mix air atomizing spray nozzle assembly of claim 1 in which said nozzle body includes an upstream body portion having said liquid and air inlet ports and a nozzle spray tip that includes said nose portion and defines at least a part of said central liquid passageway.

8. The internal mix air atomizing spray nozzle assembly of claim 2 in which said air cap is formed with a counterbore upstream of said cylindrical cavity for receiving said insert.

9. The internal mix air atomizing spray nozzle assembly of claim 8 in which said counterbore and insert are formed with complementary frustoconical seating surfaces.

10. The internal air atomizing spray nozzle assembly of claim 1 in which said air cap discharge orifices each are oriented in skewed relation to the central axis of said air cap and liquid flow passageway.

11. An internal mix air atomizing spray nozzle assembly comprising:
a nozzle body formed with a central liquid flow passageway along a central axis thereof, said nozzle body having a liquid inlet for connection with a pressurized liquid supply and communicating with said central liquid flow passageway, said nozzle body having a downstream relatively small diameter, forwardly extending, cylindrical nose portion which defines a liquid discharge orifice of said central liquid flow passageway,
said nozzle body having an air inlet port for connection to a pressurized air source,
an air cap mounted in surrounding relation to said nose portion formed with a central mixing chamber concentric with said central liquid flow passageway and central axis into which pressurized liquid from said liquid discharge orifice discharges,
said air cap having a central opening disposed in at least partially surrounding relation to said nose portion, said air cap central opening and nozzle nose portion defining an annular air orifice coaxial with said liquid discharge orifice and central axis and in communication with said air inlet port for directing an annular pressurized air stream into said air cap mixing chamber for interaction with liquid discharging from said liquid discharge orifice for pre-atomizing the liquid into liquid particles,
said air cap having a plurality of circumferentially spaced discharge orifices for directing pre-atomized liquid particles from air cap in a conical spray pattern, said air cap discharge orifices each having an axis inclined at an acute angle relative to a first plane through said central axis, and said air cap discharge orifices each being angled at an acute angle relative to a second plane through the central air cap and liquid passageway axis disposed perpendicular to the first plane such that pre-atomized liquid particles emitted from said air cap discharge orifices are directed in both conical and tangential directions for intermingling and mixing into a full cone pattern.

12. The internal mix air atomizing spray nozzle assembly of claim 11 in which said air cap mixing chamber is defined by a cylindrical cavity within said air cap and a separate upstream insert that defines said central air cap opening.

13. The internal mix air atomizing spray nozzle assembly of claim 11 in which said air cap mixing chamber has a diameter at least 30% greater than the outer diameter of said annular air orifice.

14. The internal mix air atomizing spray nozzle assembly of claim 11 in which said air cap mixing chamber has a diameter at least 50% greater than the outer diameter of said annular air orifice.

15. The internal mix air atomizing spray nozzle assembly of claim 13 in which said air cap is formed with at least nine discharge orifices.

16. The internal mix air atomizing spray nozzle assembly of claim 13 in which said air cap is formed with at least ten discharge orifices.

17. The internal mix air atomizing spray nozzle assembly of claim 12 in which said air cap is formed with a counterbore upstream of said cylindrical cavity for receiving said insert.
